(19) United States
(12) Patent Application Publication
(10) Pub. No.: US 2008/0292249 A1
(43) Pub. Date: Nov. 27, 2008

(54) ELECTRONIC EQUIPMENT

(76) Inventors: Yasushi KIMURA, Yokohama (JP); Seiji Asai, Yokohama (JP); Yoko Okubo, Yokohama (JP); Minehiro Matsuo, Kamakura (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/022,177

(22) Filed: Jan. 30, 2008

(30) Foreign Application Priority Data
May 24, 2007 (JP) 2007-137881

(51) Int. Cl. G02B 6/36

(52) U.S. Cl. 385/90

(57) ABSTRACT

There can be realized a compact optical network unit with an optical cable provided between an optical cable housing and an optical video terminal housing. When the optical video terminal housing is opened and closed by rotating 90 degrees or more about hinges connecting the two housings, the extra length of the optical cable is absorbed in an optical cable length adjustment portion of the optical video terminal housing as well as in an optical cable housing portion. Thus, the optical cable can be smoothly moved through a cable guide which is a base point of the movable portion of the optical cable, without an operation to prevent the optical cable from being stuck.

### CLAIM OF PRIORITY

The present application claims priority from Japanese patent application serial no. 2007-137881, filed on May 24, 2007, the content of which is hereby incorporated by reference into this application.

### BACKGROUND OF THE INVENTION

The present invention relates to electronic equipment, and more particularly to electronic equipment in which an optical cable connected between a movable portion and a fixed portion is prevented from being stuck while maintaining a constant radius upon opening and closing of the movable portion.

Structures for processing extra optical cable length have been described in JP-A No. Hei 10-224295 and JP-A No. 2006-3813. In the invention of JP-A No. Hei 10-224295, a movable portion can be opened and closed about 90 degrees relative to a fixed portion. The optical fiber is subjected to extra length processing while maintaining a specified radius by a holder. This structure has a portion called a U-shaped loop portion to provide the optical cable to the movable portion side, in which the U-shaped loop portion should have a space to allow opening and closing movement of the movable portion at about 90 degrees. Thus, it requires a width-direction space of (2×bending radius)×2 so as to maintain a specific radius of the optical fiber upon movement of the movable portion, in addition to (2×bending radius) in the extra length processing portion of the optical cable. Further, the structure has not been designed to largely open the movable portion with a limited range of movement from 0 to about 90 degrees.

Similarly, in the invention described in JP-A No. 2006-3813, the movable portion can be opened and closed about 90 degrees relative to the fixed portion. This structure has an optical fiber which is loosened and fixed to the fixed portion side so as to maintain a specified radius upon opening and closing of the movable portion. The extra length of the optical fiber is loosened in an S shape and is fixed in the vicinity of the shaft of the fixed portion. Thus, it requires a space in the width and height directions.

The invention of JP-A No. Hei 10-224295 absorbs a problem such as twisting of the optical fiber due to the movable portion being rotated about a hinge portion, by the U-shaped loop portion (2×bending radius or more). However, it requires a large area for the extra optical cable length processing. Further, the structure has been designed without taking into account workability of optical fiber installation, with a limited rotation angle range of about 90 degrees in the movable portion.

The invention of JP-A No. 2006-3813 absorbs the problem such as twisting of the optical fiber due to the movable portion being rotated about the hinge portion, by the S-shaped extra length processing portion. However, the fixed optical fiber is unstable due to the movement of the movable portion. Further, the structure has been designed without taking into account workability of optical fiber installation, with a limited rotation angle range of about 90 degrees in the movable portion, similarly to the case of JP-A No. 2008-224295.

JP-A No. Hei 9-181464 discloses a cable housing portion. In FIGS. 3 and 4, the cable housing portion includes an enclosure 1 mounted to a board, and an openable and closable cover 2 attached to the enclosure 1, in which a space for housing an extra length portion of a cable 5 is provided within the cover. When the cover 2 is opened or closed, cable supports 32 move along shafts 6 while the extra length portion of the cable 5 maintains an appropriate curvature. In this way, the stress applied to the cable is released, thereby preventing the characteristics and durability of the optical cable from being deteriorated.

Further, JP-A No. Hei 9-046066 discloses a space-saving cable installation structure. In FIGS. 1 and 2, the cable installation structure includes an enclosure 1 of electronic equipment, an openable and closable door 2 held by hinges 3, a cable 4 to be installed between the enclosure 1 and the door 2, and nylon clips 8, 9 for holding the cable 4 and an extra length portion 6 of the cable 4. When the door 2 is opened or closed, the cable 4 maintains an S shape while the position of the curved portion is moved and the size of the curved portion is changed.

### SUMMARY OF THE INVENTION

The present invention addresses the above described problems of the related art, and provides electronic equipment including an enclosure connected by an optical cable between a movable portion and a fixed portion, in which the optical cable can be smoothly moved while maintaining a bending radius, when the movable portion is repeatedly moved at an opening/closing angle from 0 degree (fully closed state) to 180 degrees (fully opened state) relative to the enclosure.

The above can be achieved by electronic equipment including: a first mounting portion having a first thickness; a second mounting portion having a second thickness rotatably connected to the first mounting portion; and an optical fiber connecting the first and second mounting portions. The second mounting portion includes a difference adjustment portion in which a portion of the optical fiber is loosened in the second thickness direction, thereby changing the amount of loosening of the optical fiber in the difference adjustment portion in response to an angle at which the second mounting portion is connected to the first mounting portion.

### BRIEF DESCRIPTION OF THE DRAWINGS

Preferred embodiments of the present invention will now be described in conjunction with the accompanying drawings, in which:

FIG. 1 is a block diagram of an optical access system;

FIG. 2 is a perspective view of a state in which an optical video terminal unit of an optical network unit is opened 90 degrees;

FIG. 3 is a perspective view of a state in which the optical video terminal unit of the optical network unit is opened 180 degrees;

FIG. 4 is an exploded perspective view of a state in which the optical video terminal unit of the optical network unit is opened 180 degrees;

FIG. 5 is a front view of a state in which the optical video terminal unit of the optical network unit is opened 180 degrees;

FIG. 6 is a cross-sectional view taken along line A-A of FIG. 5;

FIG. 7 is an enlarged view of B portion of FIG. 5;

FIG. 8 is a front view of a state in which the optical video terminal unit of the optical network unit is opened 180 degrees;

FIG. 9 is a cross-sectional view taken along line A-A of FIG. 8;

FIG. 10 is an enlarged view of B portion of FIG. 8;

FIG. 11 is an enlarged view of C portion of FIG. 8;

FIG. 12 is a left side view of a state in which the optical video terminal unit of the optical network unit is opened 90 degrees;

FIG. 13 is a cross-sectional view taken along line A-A of FIG. 12;

FIG. 14 is a front view of a state in which the optical video terminal unit of the optical network unit is fully closed; and

FIG. 15 is a cross-sectional view taken along line A-A of FIG. 14.

### DESCRIPTION OF THE PREFERRED EMBODIMENT

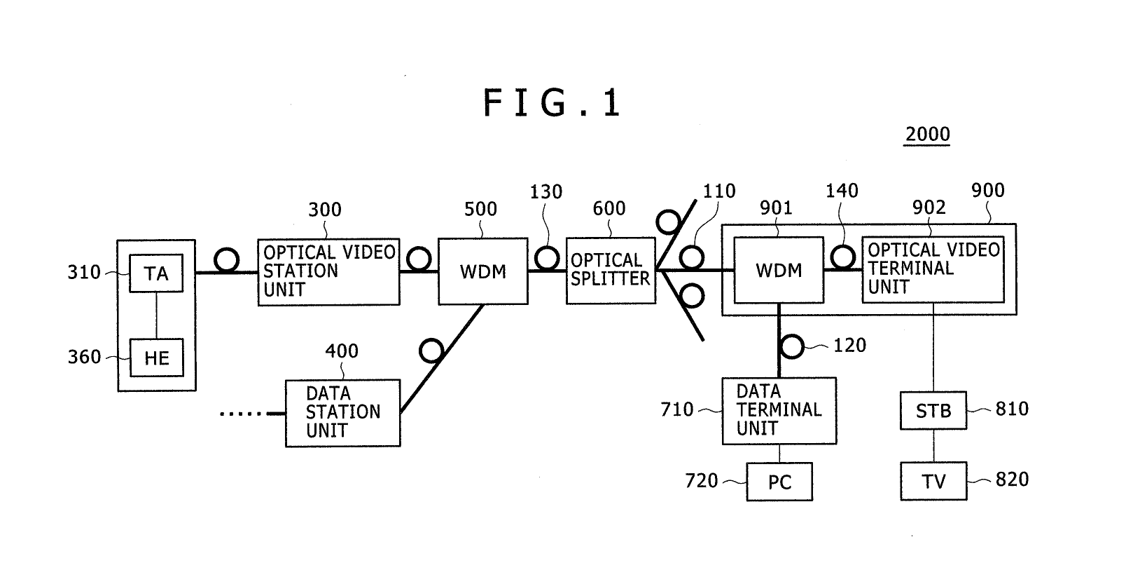

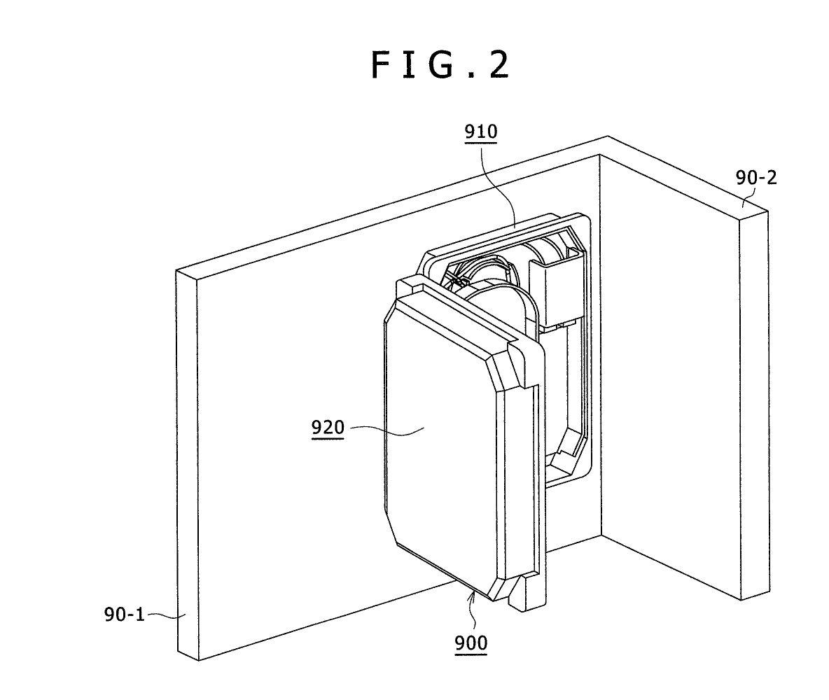

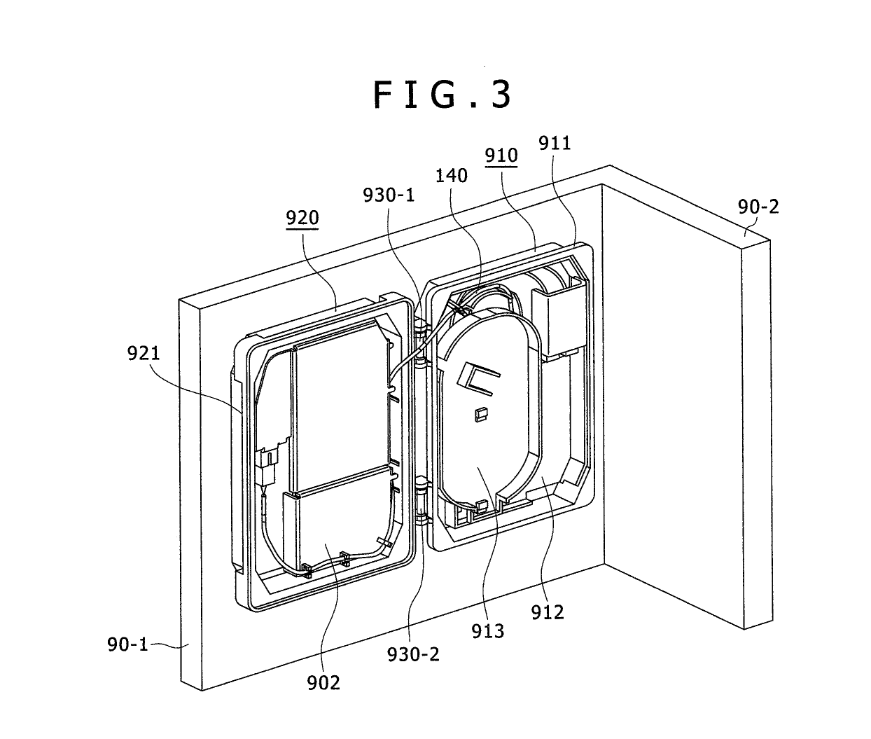

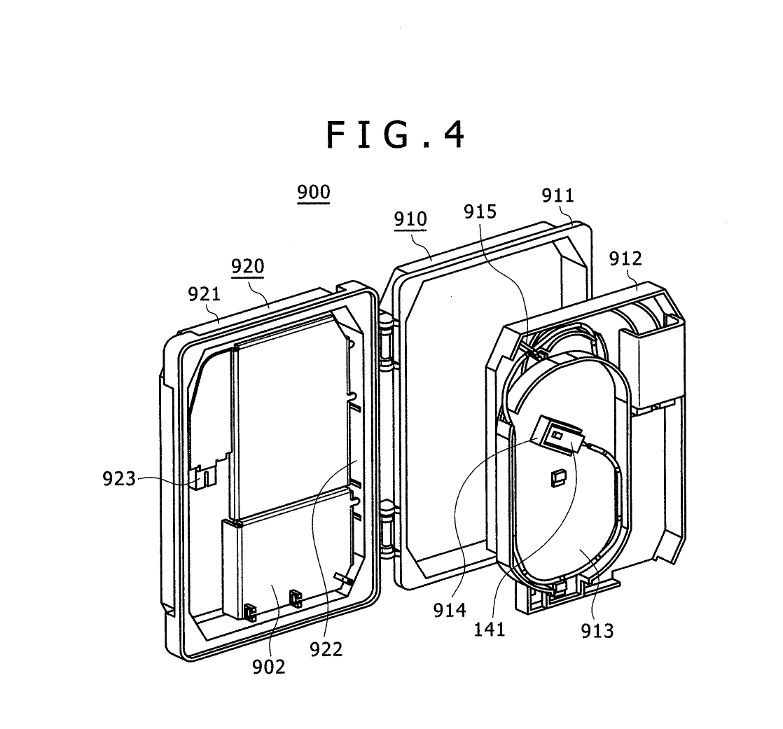

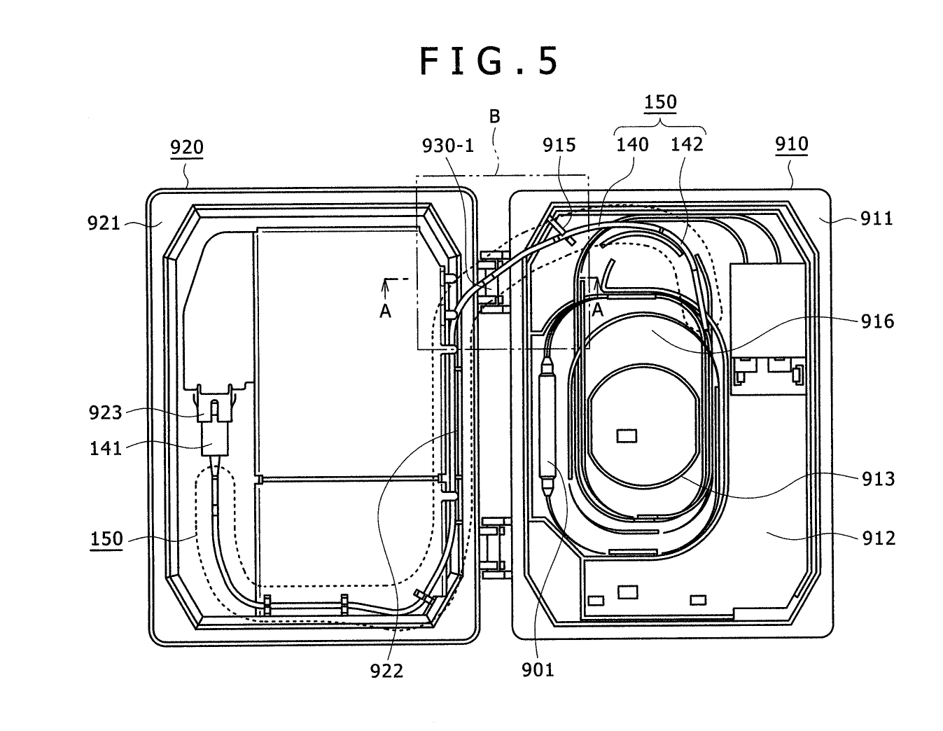

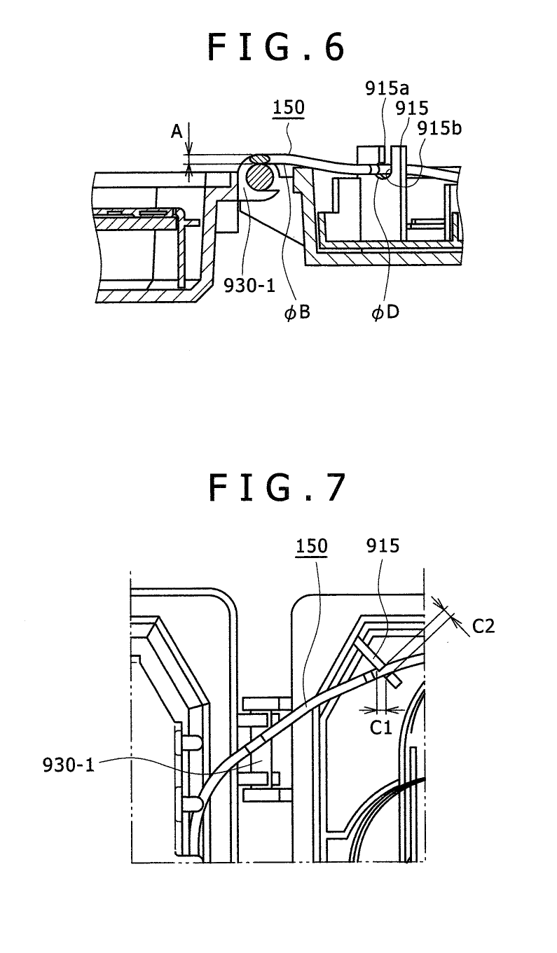

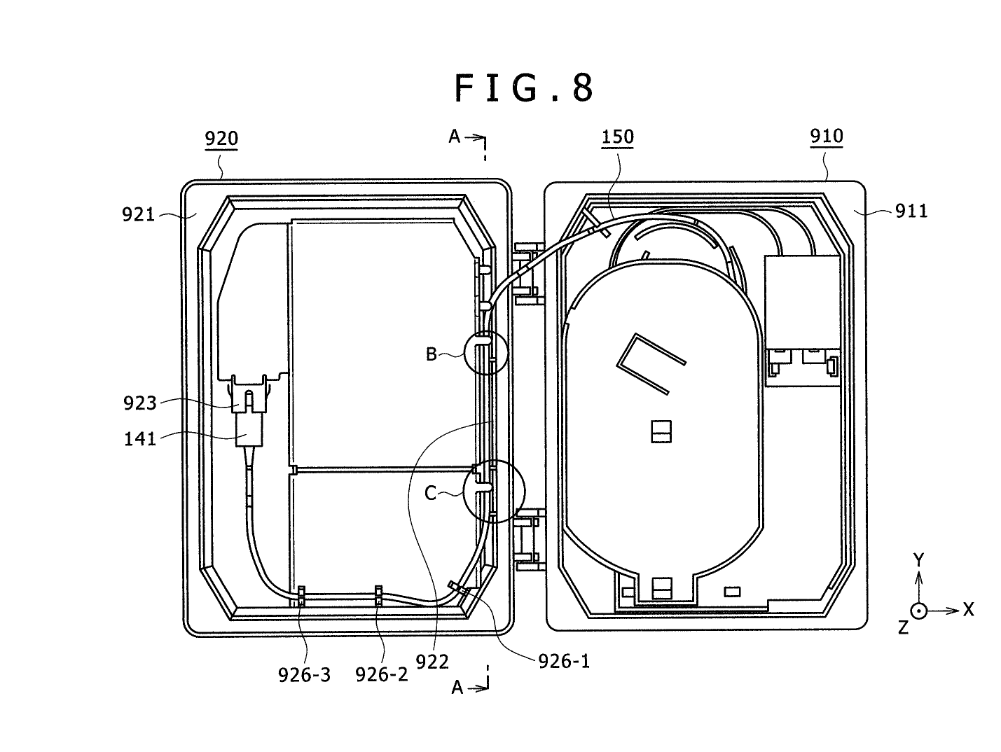

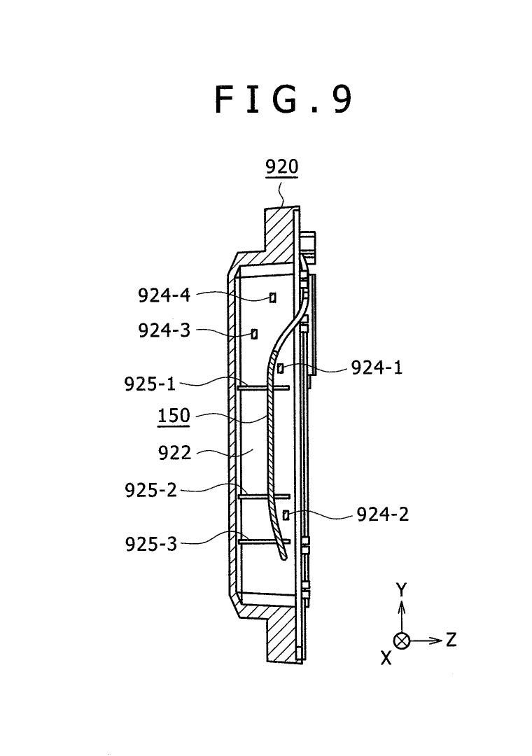

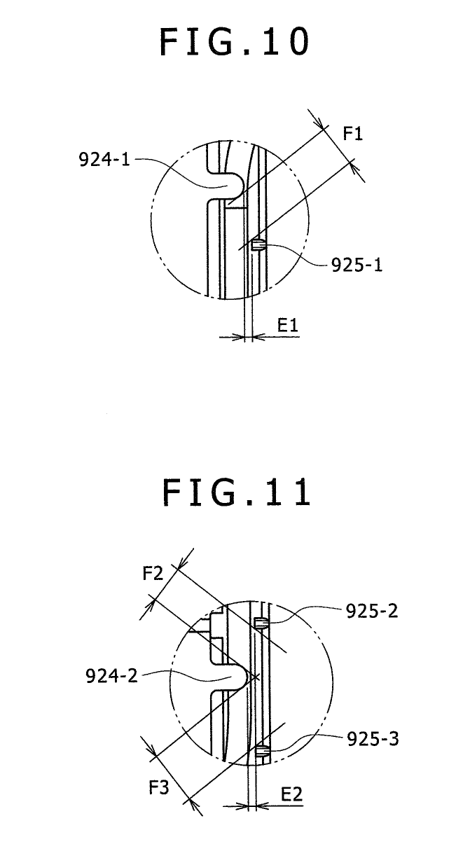

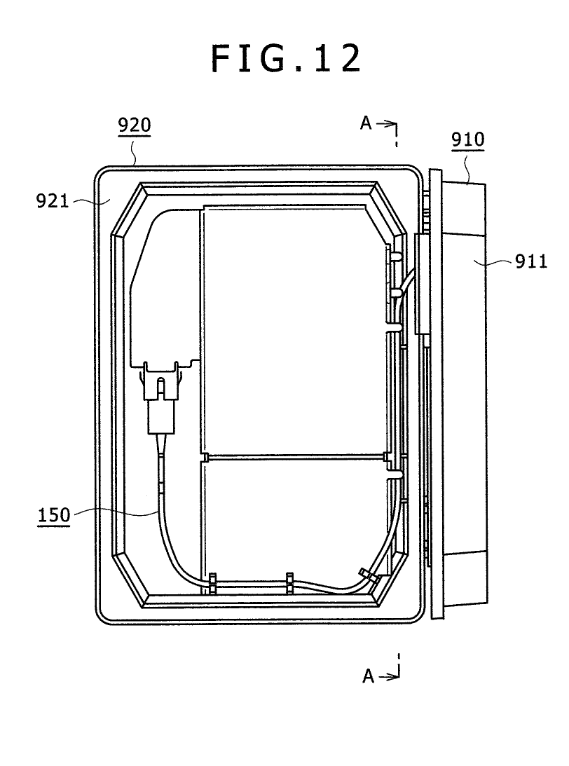

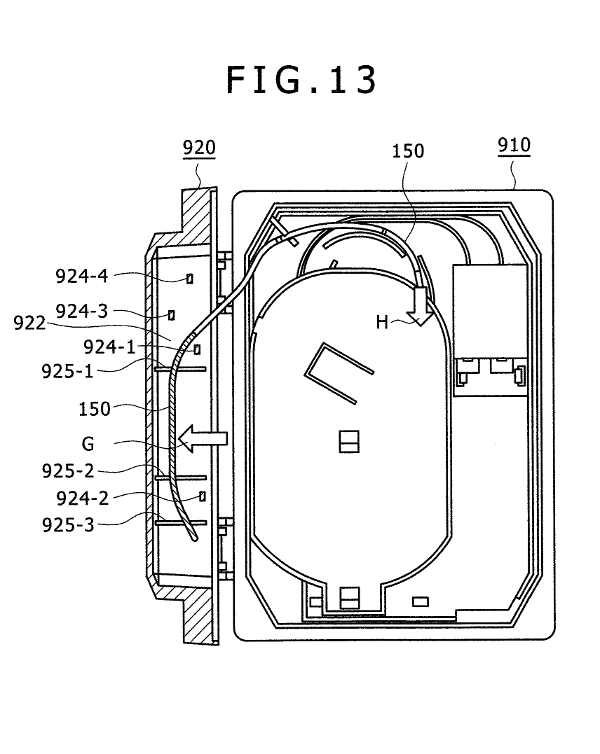

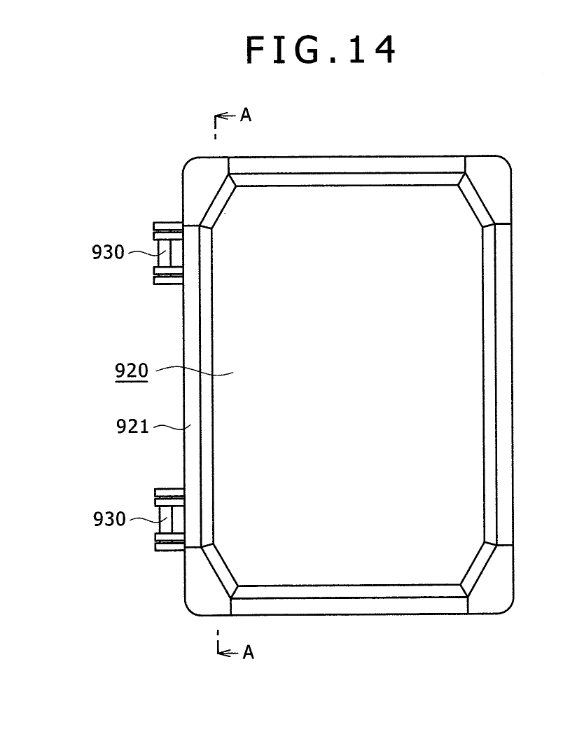

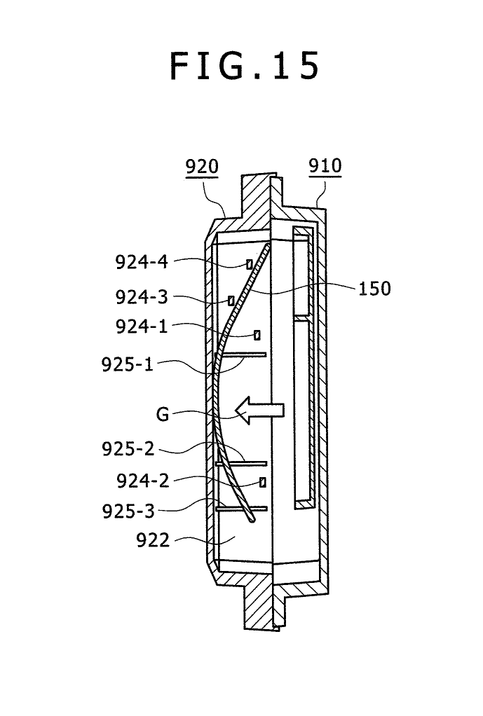

Hereinafter, a preferred embodiment will be described by examples with reference to FIGS. 1 to 15. Like or corresponding parts are denoted by the same reference numerals and the description will not be repeated. Here, FIG. 1 is a block diagram of an optical access system. FIG. 2 is a perspective view of a state in which an optical video terminal unit of an optical network unit is opened 90 degrees. FIG. 3 is a perspective view of a state in which the optical video terminal unit of the optical network unit is opened 180 degrees. FIG. 4 is an exploded perspective view of a state in which the optical video terminal unit of the optical network unit is opened 180 degrees. FIG. 5 is a front view of a state in which the optical video terminal unit of the optical network unit is opened 180 degrees. FIG. 6 is a cross-sectional view taken along line A-A of FIG. 5. FIG. 7 is an enlarged view of B portion of FIG. 5. FIG. 8 is a front view of a state in which the optical video terminal unit of the optical network unit is opened 180 degrees. FIG. 9 is a cross-sectional view taken along line A-A of FIG. 8. FIG. 10 is an enlarged view of B portion of FIG. 8. FIG. 11 is an enlarged view of C portion of FIG. 8. FIG. 12 is a left side view of a state in which the optical video terminal unit of the optical network unit is opened 90 degrees. FIG. 13 is a cross-sectional view taken along line A-A of FIG. 12. FIG. 14 is a front view of a state in which the optical video terminal unit of the optical network unit is fully closed. FIG. 15 is a cross-sectional view taken along line A-A of FIG. 14.

In FIG. 1, an optical access system 2000 includes: an optical video station unit 300, a data station unit 400, and a Wavelength Division Multiplexer (WDM) 500, which are located in a station; a trunk line optical fiber 130; an optical splitter 600; 32 branched optical fibers 110; and an optical network unit 900 in a subscriber's house.

The optical video station unit 300 is connected to Head End (HE) 360 for transmitting video information through Transmitter Amplifier (TA) 310. The optical network unit 900 includes a WDM filter 901, an optical video terminal unit 902, and an optical fiber 140 connecting therebetween. The WDM filter 901 is connected to the optical fibers 110 and to an optical fiber 120. The other end of the optical fiber 120 is connected to a data terminal unit 710. The data terminal unit 710 is connected to PC 720 to provide two-way data communications through the data station unit 400. The optical video terminal unit 902 is connected to a TV 820 through Set Top Box (STB) 810.

An optical video signal transmitted by the optical video station unit 300 is multiplexed with a downstream data optical signal in the WDM 500, and is transmitted to the trunk line optical fiber. The multiplexed optical signal is divided into 32 segments in the optical splitter 600, and is transmitted to the optical network unit 900 through the optical fiber 110. The WDM filter 901 separates the downstream data optical signal and the optical video signal, and transmits them to the data terminal unit 710 and the optical video terminal unit 902, respectively. The data terminal unit 710 converts the downstream data optical signal to an electrical signal and transmits the electrical signal to the PC 720. The optical video terminal unit 902 converts the optical video signal to an electrical signal and transmits the electrical signal to the STB 810. Then, the TV 820 displays video and outputs sound based on the video signal selected in the STB 810.

An upstream data signal from the PC 720 is converted to a data optical signal in the data terminal unit 710. The data optical signal is transmitted to each of the optical fibers 110 through the WDM 901 at a timing based on an instruction from the data station unit 400. The optical splitter 600 multiplies the upstream data optical signals from each of the optical network units 900, and transmits the multiplied signal to the trunk line optical fiber 130. The WDM 500 transmits the time divided multiplexed upstream data optical signal to the data station unit 400.

First, the configuration of the key functional block of the optical network unit will be described with reference to FIGS. 2 to 4. In FIG. 2, the optical network unit 900 includes an optical cable housing 910 and an optical video terminal housing 920. The optical network unit 900 is provided in a corner between walls 90-1 and 90-2 in such a way that the optical cable housing 910 is fixed to the wall 90-1. The optical video terminal housing 920 is connected to the optical cable housing 910 by hinges not shown. In this case, the mounting of the optical network unit close to the wall 90-2 is difficult with the optical video terminal housing 920 at an opening angle of 90 degrees.

However, as shown in FIG. 3, the actual opening angle of the optical video terminal housing 920 is 180 degrees, so that it is possible to mount the optical network unit 900 to the wall 90-1 in a position close to the wall 90-2. Incidentally, the thickness of the optical cable housing 910 and the thickness of the optical video terminal housing 920 are set to approximately the same value.

In FIG. 3, the optical cable housing 910 includes: an optical cable housing case 911; an optical cable housing base tray 912 to be fixed to the optical cable housing case 911; and an optical cable housing sub tray 913 to be fixed to the optical cable housing base tray 912. The optical video terminal housing 920 includes: an electronic device housing case 921; and the optical video terminal unit 902 to be fixed to the electronic device housing case 921. The optical cable housing 910 and the optical video terminal housing 920 are connected by the optical cable 140.

Further, the optical cable housing case 911 has optical cable housing case hinge portions, and the electronic device housing case 921 has electronic device housing case hinge portions. The hinge portions are engaged with each other to form hinges 930-1, 930-2. As a result, the optical video terminal housing 920 can be opened and closed by rotating about the hinges 930. With this configuration, it is possible to easily connect the optical cable 140 housed in the optical cable housing 910, to the optical video terminal housing 920.

FIG. 4 shows the optical cable housing base tray 912 to be installed in the optical cable housing 910. Upon installation, the optical cable housing sub tray 913 and an SC connector 141, which is attached to the tip of the optical cable 140 and is mounted to the SC connector housing portion 914, are fixed to the optical cable housing base tray 912. Because the optical cable 140 is mounted to the optical cable housing sub tray 913, the optical cable housing base tray 912 can be removed from the optical cable housing case 911. In this way, when a problem occurs in the optical cable 140, it is possible to easily replace the optical cable 140 by replacing the optical cable housing base tray 912. Further, the optical cable 140 mounted to the optical cable housing sub tray 913 is housed in the SC connector housing portion 914 of the optical cable housing sub tray 912, at a base point of an optical cable guide 915. The length of the optical cable 140 from the optical cable guide 915 to the SC connector housing portion 914 is set to the same length as that from the optical cable guide 915 to an SC adaptor 923. This eliminates the need to adjust the length of the optical cable 140, providing excellent workability.

Referring to FIG. 5, a description will be given of the relationship between the optical cable housing 910 and the optical video terminal housing 920. The optical cable 140 extends from the WDM filter 901 to the SC connector 141. The extra length of the optical cable 140 from the WDM filter 901 is wound within an optical cable housing portion 916. In FIG. 5, a movable optical cable 150 is a portion between the SC connector 141 and the optical cable housing portion 916, which is surrounded by a dotted line. The optical cable 140 is covered with an optical cable protection tube 142. When the optical video terminal housing 920 is opened or closed, the movable optical cable 150 is moved in the vertical direction in the view. At this time, the optical cable 140 with the optical cable protection tube 142 is harder than without such a protection tube, and is prevented from being twisted. As a result, the optical cable 140 can be smoothly moved without being damaged.

Hereinafter, a description will be given of the process of connecting the movable optical cable 150 to the SC adapter 923. First, the SC connector 141 housed in the SC connector housing portion 914 of the optical cable housing sub tray 912 is removed. The removed movable optical cable 150 is guided by the optical cable guide 915. The movable optical cable 150 is extended to the optical video terminal housing 920 by a selected route through the upper portion of the hinge 930-1 of the optical cable housing case shown in FIG. 5.

In FIG. 6, assuming that A is a gap height of the hinge 930 and B is a diameter of the protection tube 142, their relationship is defined as A≧φB and A≈φB. As a result, the movable optical cable 150 is protected without sticking out.

In FIG. 7, the movable optical cable 150 is guided by the optical cable guide 915 projecting from the optical cable housing base tray 912. The relationship among the diameter φB of the movable optical cable 150, dimension C1 of an optical cable lead-in groove 915a of the optical cable guide 915, and dimension C2 angled about 45 degrees to the optical cable lead-in groove 915a, is defined as C2<φB<C1. In the state of normal operation, the movable optical cable 150 is angled about 45 degrees with the optical cable lead-in groove 915a. Thus, the movable optical cable 150 is not removed from the optical cable guide 915 in the upward vertical direction in the view of FIG. 7 (in the upward direction in the view of FIG. 6). On the other hand, when the movable optical cable 150 is made parallel to C1 of the optical cable lead-in groove 915a, the movable optical cable 150 can easily be removed therefrom.

The cable guide hole 915b has a diameter of φD (2×φB), and the relationship φB<φD/√2=√2×φB is given with the optical cable 150 angled about 45 degrees in normal operation. Thus, although the movable optical cable 150 is moved due to opening and closing of the optical video terminal housing 920, a smooth movement can be achieved in the cable guide 915 in the view of FIG. 7, namely, in the extending direction of the movable optical cable.

In FIGS. 8 to 11, before the SC connector 141 is connected to the SC adaptor 923 with the optical video terminal housing 920 being opened, it is necessary to house the movable optical cable 150 into an optical cable length adjustment portion 922. Hereinafter, a description will be given of the procedure for housing the movable optical cable 150 into the optical cable length adjustment portion 922.

In FIGS. 9 and 10, the movable optical cable 150 is provided between a hook 924-1 and a rib 925-1. The relationship among the diameter φB, and gaps E1, F1 between the hook 924-1 and the rib 925-1, is defined as E1<φB<F1. The dimension in the z-axis direction of the hook 924 is short, φB<F1, so that the movable optical cable 150 can be easily provided between the hook 924-land the rib 925-1, and can be housed in the optical cable length adjustment portion 922. Similarly, in FIGS. 9 and 11, the relationship of gaps E2, F2 between a hook 924-2 and a rib 925-2 is defined as E2<φB<F2, and the relationship of gaps E2, F3 between the hook 924-2 and a rib 925-3 is defined as E2<φB<F3, respectively. Because of such dimension relationships, the movable optical cable 150 is not removed in the z-axis direction from between the hooks 924 and the ribs 925. Further, the movable optical cable 150 can be loosened in the negative z-axis direction in the optical cable length adjustment portion 922. The movable optical cable 150 is loosened with the optical video terminal housing 920 being opened, so that it is possible to gradually increase the amount of loosening as the optical video terminal housing 920 is gradually closed.

In FIG. 8, the movable optical cable 150 rises from the optical cable length adjustment portion 922, and is fixed by clamps 926-1 to 926-3. Then, the SC connector 141 is connected to the SC adaptor 923. In this way, the connection operation of the movable optical cable 150 is completed. It is possible to facilitate the connection operation of the movable optical cable 150 by opening the optical video terminal housing 920.

The optical network unit 900 has the structure in which the optical video terminal housing 920 is rotated about the hinges 930. It is assumed that X is a length of the movable optical cable 150 from the cable guide 915 to the SC adaptor 923 with the optical video terminal housing 920 open 180 degrees, Y is a length of the movable optical cable 150 from the cable guide 915 to the SC adaptor 923 with the optical video terminal housing 920 open 90 degrees, and Z is a length of the movable optical cable 150 from the cable guide 915 to the SC adaptor 923 with the optical video terminal housing 920 closed. The relationship of these lengths is defined as X>Y>Z. During a period of time when the optical video terminal housing 920 is closed from the 180 degree state, the difference of the length (X-Z) of the movable optical cable 150 should be absorbed in the optical cable length adjustment portion 922 and in the optical cable housing portion 916. In other words, when the optical video terminal housing 920 is closed to 90 degrees as shown in FIGS. 12 and 13 from the 180 degree state of FIG. 8, the movable optical cable 150 absorbs the difference of the length (X-Y) in the movable optical cable 150 by moving in a direction of arrow G (negative z-axis direction), because the movable optical cable 150 has been loosened in the negative z-axis direction in the optical cable length adjustment portion 922. Next, when the optical video terminal housing 920 is fully closed as shown in FIGS. 14 and 15 from the 90 degree state of FIG. 12, the movable optical cable 150 further moves in the direction of arrow G in the optical cable length adjustment portion 922. The movable optical cable 150 comes into contact with hooks 924-3, 924-4, and absorbs the difference of the length (Y-Z). The hooks 924-3, 924-4 serve as a guide for the movable optical cable 150 to maintain the specified radius. In this way, when the optical video terminal housing 920 is closed, it is possible to easily absorb the difference of the length of the movable optical cable 150 in the G direction of the optical cable length adjustment portion 922, while maintaining the specified radius, by the lifting and guide functions provided in the narrow optical cable length adjustment portion 922. Further, when the optical video terminal housing 920 is opened, it is possible to maintain the specified radius by the movement of the movable optical cable 150 in the direction opposite to the G direction, using the length of the movable optical cable 150 absorbed in the optical cable length adjustment portion 922. In addition, even in the worst case that the movable optical cable 150 is in the state of FIG. 15 with the optical video terminal housing 920 open 180 degrees and that the difference of the length of the movable optical cable 150 is not completely absorbed in the optical cable length adjustment portion 922, the movable optical cable 150, which is not clamped by the cable guide 915, can also move in H direction of FIG. 13. As a result, the movable optical cable 150 operates to maintain the specified radius.

As described above, by providing the narrow optical cable length adjustment portion 922 to the optical video terminal housing 920, it is possible to safely provide the optical cable 140 to be connected to the optical video terminal housing 920 and to the optical cable housing 910. As a result, it is possible to provide the optical network unit 900 capable of being reduced in size. Incidentally, in the above described embodiment, the optical cable length adjustment portion is provided in the optical video terminal housing. However, it is also possible to provide the optical cable length adjustment portion in the optical cable housing.

According to the present invention, the movement of the optical cable is easily absorbed upon opening and closing of the electronic equipment portion, by the space between the electronic device portion and the electronic device housing case on the hinge side to serve as the optical cable length adjustment portion. Hence, it is possible to configure the optical fiber communication equipment that can maintain the specified bending radius of the optical cable which is the connection cable between the electronic device portion and the optical cable housing portion, by the easy opening/closing operation in the minimal space.

What is claimed is:

1. Electronic equipment comprising:
a first mounting portion having a first thickness;
a second mounting portion having a second thickness rotatably connected to the first mounting portion; and
an optical fiber connecting the first mounting portion and the second mounting portion,
wherein said second mounting portion includes a difference adjustment portion in which a portion of the optical fiber is loosened in the second thickness direction, thereby changing the amount of loosening of the optical fiber in the difference adjustment portion in response to an angle at which the second mounting portion is connected to the first mounting portion.

2. The electronic equipment according to claim 1,
wherein said first thickness and said second thickness are approximately equal to each other.

3. The electronic equipment according to claim 1,
wherein said difference adjustment portion includes a portion for maintaining the loosening direction of the optical fiber.

4. The electronic equipment according to claim 2,
wherein said difference adjustment portion includes a portion for maintaining the loosening direction of the optical fiber.

5. The electronic equipment according to claim 1,
wherein said first mounting portion includes a guide portion for movably holding the optical fiber in the extending direction of the optical fiber.

6. The electronic equipment according to claim 2,
wherein said first mounting portion includes a guide portion for movably holding the optical fiber in the extending direction of the optical fiber.

7. The electronic equipment according to claim 3,
wherein said first mounting portion includes a guide portion for movably holding the optical fiber in the extending direction of the optical fiber.

8. The electronic equipment according to claim 4,
wherein said first mounting portion includes a guide portion for movably holding the optical fiber in the extending direction of the optical fiber.

9. The electronic equipment according to claim 1,
wherein said optical fiber is protected with a tube.

10. The electronic equipment according to claim 2,
wherein said optical fiber is protected with a tube.

11. The electronic equipment according to claim 3,
wherein said optical fiber is protected with a tube.

12. The electronic equipment according to claim 4,
wherein said optical fiber is protected with a tube.

13. The electronic equipment according to claim 5,
wherein said optical fiber is protected with a tube.

14. The electronic equipment according to claim 6,
wherein said optical fiber is protected with a tube.

15. The electronic equipment according to claim 7,
wherein said optical fiber is protected with a tube.

16. The electronic equipment according to claim 8,
wherein said optical fiber is protected with a tube.
